(19) United States
(12) Patent Application Publication
(10) Pub. No.: US 2017/0294251 A1
(43) Pub. Date: Oct. 12, 2017

(54) ULTRATHIN POSITIVE TEMPERATURE COEFFICIENT SHEET AND METHOD FOR MAKING SAME

(71) Applicant: LITTELFUSE, INC., Chicago, IL (US)

(72) Inventors: Jianhua Chen, Sunnyvale, CA (US); Chun-Kwan Tsang, Morgan Hill, CA (US)

(73) Assignee: LITTELFUSE, INC., Chicago, IL (US)

(21) Appl. No.: 15/094,164

(22) Filed: Apr. 8, 2016

(51) Int. Cl. H01C 7/00; H01C 17/00; H01C 7/02

(52) U.S. Cl. CPC H01C 7/008; H01C 7/028; H01C 17/00

(57) ABSTRACT

A method for manufacturing a sheet of positive temperature coefficient (PTC) material includes providing a PTC material, grinding the PTC material into a powder, and inserting the ground PTC material into a press. The ground PTC material is compressed within the press until the PTC material defines a planar shape. The PTC material is then removed from the press to thereby provide a PTC sheet.

### BACKGROUND

### Field

The present invention relates generally to positive temperature coefficient material. More specifically, the present invention relates to an ultrathin sheet of positive temperature coefficient material and a method for making the same.

### Description of Related Art

Positive temperature coefficient (PTC) devices are typically utilized in circuits to provide protection against over current conditions. PTC material in the device is selected to have a relatively low resistance within a normal operating temperature range of the PTC device, and a high resistance above the normal operating temperature of the PTC. For example, a PTC device may be placed in series with a battery terminal so that all the current flowing through the battery flows through the PTC device. The temperature of the PTC device gradually increases as current flowing through the PTC device increases. When the temperature of the PTC device reaches an “activation temperature,” the resistance of the PTC device increases sharply. This in turn sharply reduces the current flow through the PTC device to thereby protect the battery from an overcurrent condition.

Existing PTC devices normally include a core material having PTC characteristics surrounded by a package that comprises a barrier/insulation material. Conductive pads are provided on the outside of the package and electrically coupled to opposite surfaces of the core material so that current flows through a cross-section of the core material. The distance between the surfaces through which the current flows is typically greater than 125 μm, which places a limitation on the minimum size of the PTC device.

Other problems with existing PTC devices will become apparent in view of the disclosure below.

### SUMMARY

In one aspect, a method for manufacturing a sheet of positive temperature coefficient (PTC) material includes providing a PTC material, grinding the PTC material into a powder, and inserting the ground PTC material into a press. The ground PTC material is compressed within the press until the PTC material defines a planar shape. The PTC material is then removed from the press to thereby provide a PTC sheet.

In a second aspect, a method for manufacturing a sheet of positive temperature coefficient (PTC) material includes mixing a conductive filler and dissolved polymer into a PTC ink solution. The solution is spread over a planar surface. The solution is then dried and removed from the planar surface to thereby provide a PTC sheet.

In a third aspect, a positive temperature coefficient (PTC) device includes a conductive filler and a polymer matrix. A distance between first and second opposite surfaces of the PTC device may be less than 50 μm or less than 20 μm.

### BRIEF DESCRIPTION OF THE DRAWINGS

FIG. 1 illustrates a first exemplary process for manufacturing an ultrathin PTC sheet;

FIGS. 2A and 2B illustrate exemplary operations of the process of FIG. 1;

FIGS. 2C and 2D illustrate an exemplary PTC sheet manufactured via the process above, and a thickness of the PTC sheet, respectively;

FIG. 3 is a chart that illustrates the performance characteristics of a PTC sheet having a thickness of about 48 μm that was formed via the process described above;

FIG. 4 illustrates a second exemplary process for manufacturing an ultrathin PTC sheet;

FIGS. 5a-5c illustrate exemplary operations of the process of FIG. 4;

FIG. 6 is a chart that illustrates the performance characteristics of a PTC sheet having a thickness of about 15 μm that was formed via the process of FIG. 4;

FIG. 7 illustrates an exemplary apparatus for mass-producing an ultrathin PTC sheet using the process of FIG. 4;

FIG. 8 illustrates an exemplary battery that utilizes a PTC sheet formed via the process of FIG. 1 or FIG. 4; and

FIGS. 9A-9C illustrate exemplary free standing PTC device embodiments.

### DETAILED DESCRIPTION

Methods and systems for manufacturing ultrathin PTC sheets having nominal thicknesses of less than 50 μm or less than 20 μm are described below. The ultrathin PTC sheets can be cut into sections and inserted within the layers of a battery structure without severely impacting the size of the battery, thus overcoming the issues described above.

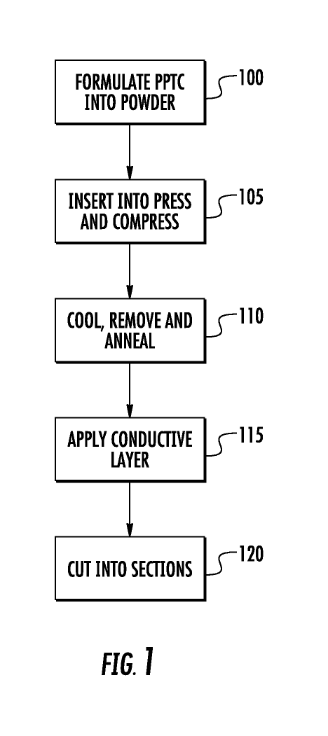

FIG. 1 illustrates a first exemplary set of operations for manufacturing an ultrathin PTC sheet. At block 100, a PTC material may be provided in a extruded slab form. The PTC material may be converted into a powdered form. For example, the PTC material provided in the extruded slab form may be ground down using a mechanical process such as milling or grinding or a different process. Other processes may be used to pulverize the PTC material into the powder form. The powder form of the PTC material includes PTC particles having a median diameter of between 0.1 μm and 50 μm.

The PTC material may include one or more conductive and polymer fillers. The conductive filler may include conductive particles of tungsten carbide, nickel, carbon, titanium carbide, or a different conductive filler or different materials having similar conductive characteristics. The size of each conductive particle may have a median diameter of between 0.1 μm and 50 μm. The polymer filler may include particles of polyvinylidene difluoride, polyethylene, ethylene tetrafluoroethylene, ethylene-vinyl acetate, ethylene butyl acrylate or different materials having similar characteristics. The size of each polymer particle may have a median diameter of between 1 μm and 1000 μm.

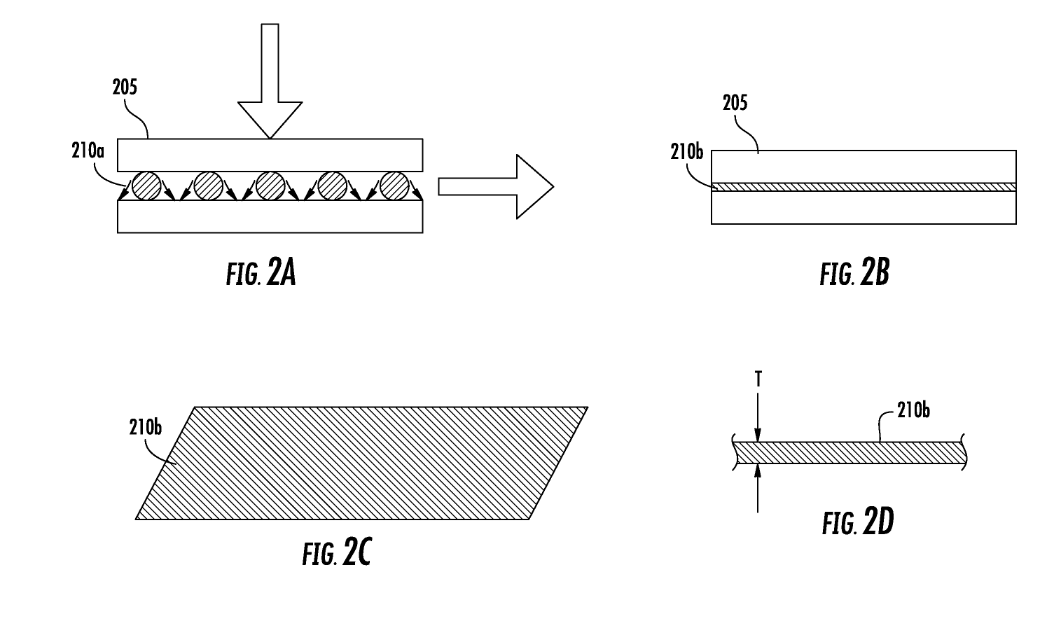

At block 105, the powdered PTC material is inserted into a press or roll press and compressed. FIGS. 2A and 2B illustrate an exemplary pressing operation. In FIG. 2A, powdered PTC material 210a (shown in an exaggerated size) is placed between opposing plates of a press 205. The powdered PTC material 210a may be applied over one of the plates of the press 205. For example, the powdered PTC material 210a may be sprayed or dropped onto the plate until a desired thickness is achieved. The thickness of the powdered PTC material 210a after application may be between about 5 μm and 130 μm.

In some implementations, a substrate material, such as copper, nickel, etc., may be initially inserted against one or both of the plates of the press 205 and the powdered PTC material 210a may be sprayed or dropped onto one of the substrates to provide a final PTC sheet having top and bottom conductive layers.

As illustrated in FIG. 2B, the plates of the press 205 are compressed against one another. During compression, the particles of the powdered PTC material deform and blend into one another until a PTC sheet 210b of the PTC material having a uniform thickness is formed. For example, for a PTC particle size of 2-3 μm, an applied thickness of 25 μm, a plate area of 400 cm², and a pressure of 5500 PSI, the particles of PTC material may be compressed into a PTC sheet having a thickness, T (FIG. 2D), of about 25 μm.

In some implementations, heat may be applied to the powdered PTC material before and/or during compression of the powdered PTC material. For example, the powdered PTC material may be heated to a temperature of the polymer melting temperature.

Returning to FIG. 1, at block 110, the PTC sheet 210b may be allowed to cool and is then removed from the press 205 as illustrated in FIG. 2C. In some implementations, an annealing process may be applied to the PTC sheet 210b to improve polymer crystallinity and polymer stress relaxation.

At block 115, in some implementations, one or more conductive layers may be applied to the PTC sheet 210b. For example, a conductive layer such as nickel foil or a different conductive material may be formed on the surfaces between which current is intended to flow. In cases where the PTC sheet 210b was compressed against one or more conductive substrates, the operations in this block may not be required.

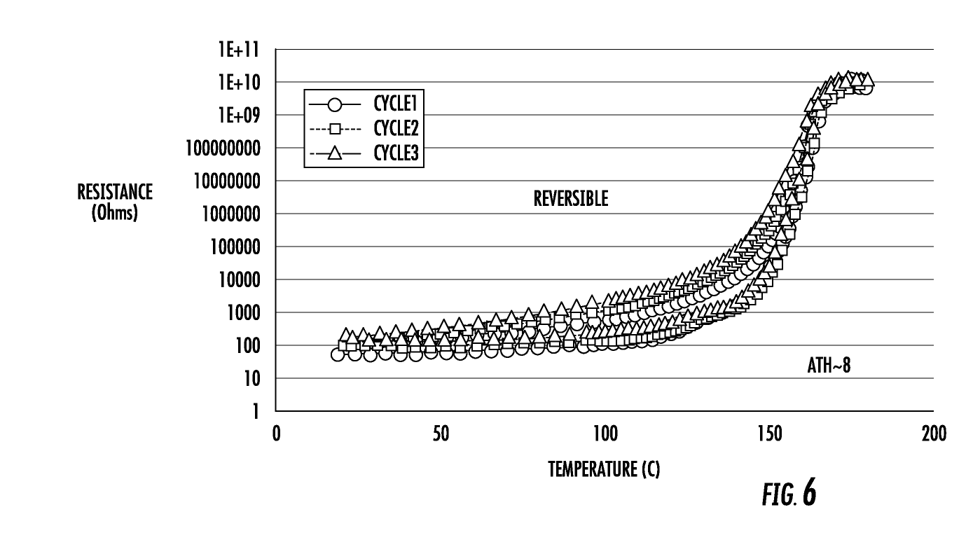

At block 125, the PTC sheet 210b may be cut into sections. The sections may then be used in a desired application. For example, the sections may be used as a protection layer in a battery (see FIG. 6, described below). The sections may be used in different applications that require protection against over current/over temperature conditions where space is at a premium.

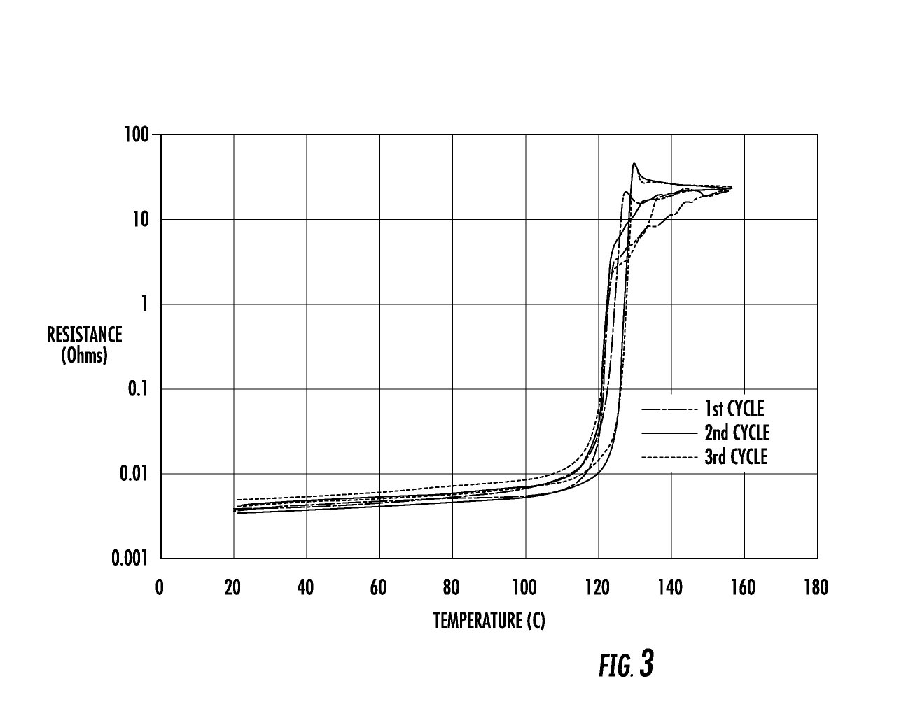

FIG. 3 is a chart that illustrates the performance characteristics of a PTC sheet having a thickness of about 48 μm that was formed via the process described above. The PTC sheet comprises tungsten carbide and polyethylene. As shown, at temperatures below 120° C., the resistance across the PTC sheet is less than about 0.01 Ohms. At around 120° C., the resistance abruptly rises to about 30 Ohms.

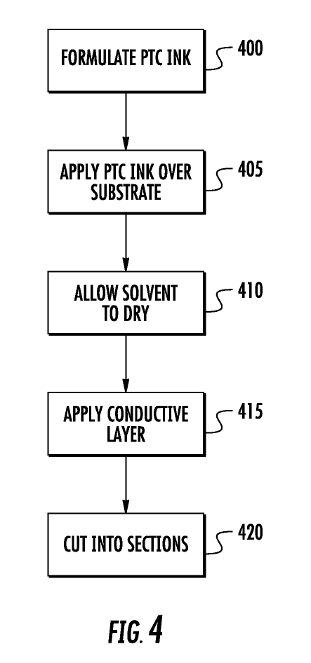

FIG. 4 illustrates a second exemplary set of operations for manufacturing an ultrathin PTC sheet. At block 400, a PTC ink solution may be formed. In one implementation, the solution is formed by mixing a conductive filler material and a polymer material in a solvent. The conductive filler may include conductive particles of metal, metal ceramic, carbon, or different materials having similar conductive characteristics. The D50 particle size of each conductive particle may have a range of between 0.1 μm and 50 μm. In this regard, particle size distributions may be calculated based on sieve analysis results, creating an S-curve of cumulative mass retained against sieve mesh size, and calculating the intercepts for 10%, 50% and 90% mass. A D50 correspond to particle size having a 50% mass.

The polymer filler may be provided in pelletized or powdered form and may include particles of semi-crystalline polymer such as polyvinylidene difluoride, polyethylene, ethylene tetrafluoroethylene, ethylene-vinyl acetate, ethylene butyl acrylate or different materials having similar characteristics. The size of each polymer particles may have a median diameter of between 1 μm and 1000 μm.

The solvent may correspond to dimethylformamide, N-Methyl-2-pyrrolidone, tetrahydrofuran, tricholorobenzene, dichlorobenzene, dimethylacetamide, dimethyl sulfoxide, cyclohexane, toluene or a different solvent capable of dissolving the selected polymer matrix. In some implementations, an additive such as an antioxidant, adhesion promoter, anti arcing material or different additive may be added to the solution to improve characteristics of the PTC sheet such as, polymer stability, voltage capability or film adhesion.

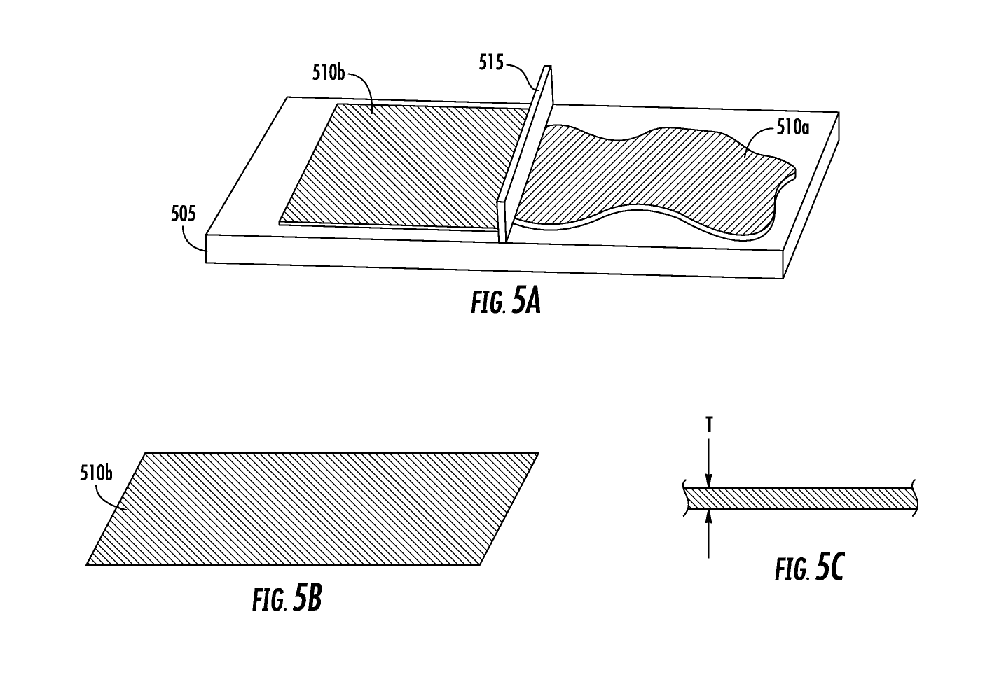

At block 405, the PTC ink is applied over a surface or substrate. For example, as illustrated in FIG. 5A, the PTC ink 510a may be poured or sprayed onto a surface 505. A blade 515 may be pulled over the PTC ink 510a to produce a uniform layer of PTC ink 510a having a desired thickness. The thickness of the uniform layer of PTC ink 510a may be between about 5 μm and 130 μm.

At block 410, the PTC ink 510a is allowed to dry, at which point the solvent evaporates out of the solution leaving behind a PTC sheet 510b having a uniform layer, as illustrated in FIG. 5B. The final thickness of the PTC sheet 510b, T (FIG. 5C), may be between about 5 μm and 130 μm. In some implementations, an annealing process may be applied to the PTC sheet 510b to improve the ATH or autotherm height (i.e., the magnitude order of the resistance change) behavior of the PTC. For example, the PTC sheet 510b may be heated to 120° C. for about two hours and then allowed to slowly cool down.

FIG. 6 is a chart that illustrates the performance characteristics of a PTC sheet 510b having a thickness of about 15 μm that was formed via the process described above in FIG. 4, including the described annealing process. The conductive filler material used in the process was tungsten carbide. The polymer filler used was polyvinylidene difluoride. The volume ratio of polymer filler to conductive filler material was about 1.1:1. As shown, at temperatures below 100° C., the resistance across the PTC sheet is about 1000 ohms or less. Above 100° C., the resistance abruptly rises to about 1×10¹⁰ Ohms.

Returning to FIG. 4, at block 415, conductive layers may be applied to the PTC sheet 510b. Where current is intended to flow between the top and bottom surfaces of the PTC sheet 510b, a conductive layer such as nickel foil or a different conductive material may be formed on the top and bottom surfaces of the PTC sheet 510b.

At block 425, the PTC sheet 510b may be cut into sections. The sections may then be used in a desired application. For example, the sections may be used as a protection layer in a battery (see FIG. 6, described below). The sections may be used in different applications that require protection against over current/over temperature where space is at a premium.

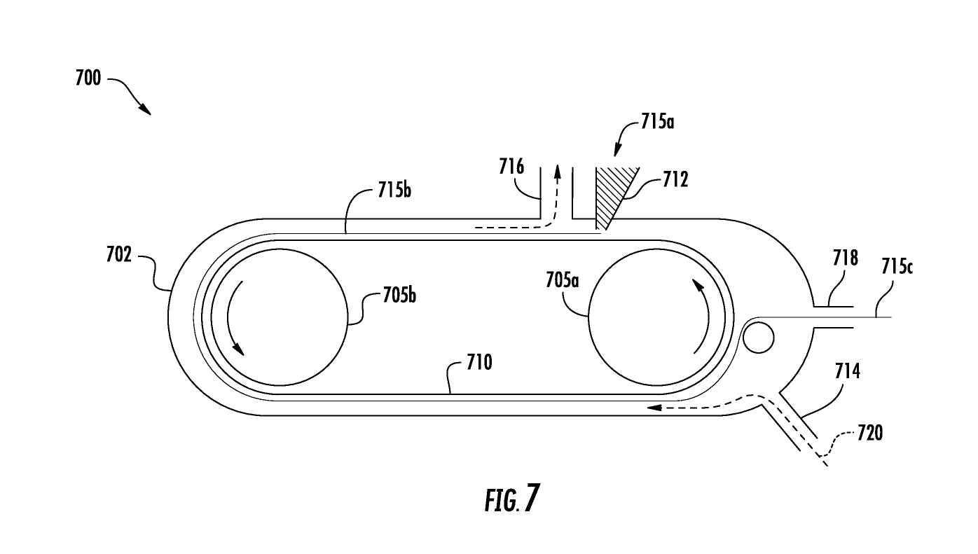

FIG. 7 illustrates an exemplary apparatus 700 for mass-producing an ultrathin PTC sheet using the process of FIG. 4. The apparatus includes a steel belt 710 wrapped around a pair of drums that rotate the steel belt 710. PTC ink 715a is poured into a hopper 712, which directs the PTC ink 715a onto the rotating steel belt 710. The distance between the bottom opening of the hopper 712 and the belt 710, and the shape of the bottom opening of the hopper 712, is selected to form a uniform layer of PTC ink 715b having a desired thickness.

The belt 710 pulls the uniform layer of PTC ink 715b through a channel defined between an outer wall 702 of the apparatus 700 and the belt 710. Drying air 720 is injected into a first opening 714 in the outer wall 702. The drying air 720 flows through the channel, over the uniform layer of PTC ink 715b, and out a second opening 716 defined in the outer wall 702. The rate of air flow and the speed of the belt 710 is selected so that the uniform layer of PTC ink 715b dries and forms a PTC sheet 715c having a uniform thickness by the time the uniform layer of PTC ink 715b reaches an extraction opening 718 of the apparatus 700. A continuous PTC sheet 715c flows out of the extraction opening 718 and may proceed to other stations for further processing. For example, additional drying may be performed. Stations for annealing, cutting, and plating the PTC sheet 715c may be provided.

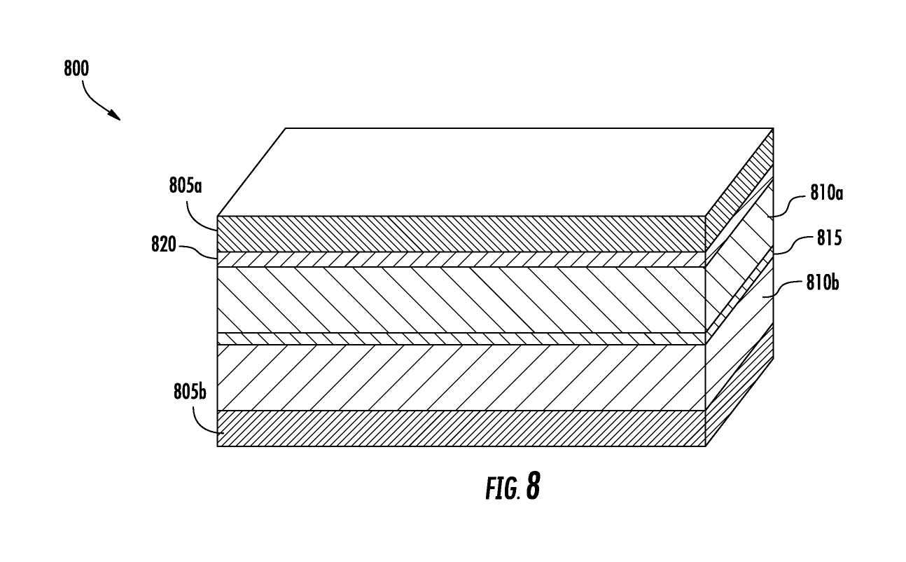

FIG. 8 illustrates an exemplary battery 800 which illustrates but one of the many uses of an ultrathin PTC sheet/layer formed by either of the processes described above. The exemplary battery 800 includes anode and cathode conductive layers 805ab, lithium electrolyte layers 810ab, a separator layer 815, and a PTC layer 820. The PTC layer 820 is disposed between the anode layer 805a and a first lithium electrolyte layer 810a. In this configuration, the PTC layer 820 is effectively in series with the battery 800 so that any current flowing through the battery 800 necessarily flows through the PTC layer 820. During an over current/over temperature condition, the resistance of the PTC layer 820 increases to thereby reduce current flow through the rest of the layers. In this way, the PTC layer 820 protects the battery 800.

The exemplary battery 800 includes anode and cathode conductive layers 805ab, lithium electrolyte layers 810ab, a separator layer 815, and a PTC layer 820. The PTC layer 820 is disposed between the anode layer 805a and a first lithium electrolyte layer 810a. In this configuration, the PTC layer 820 is effectively in series with the battery 800 so that any current flowing through the battery 800 necessarily flows through the PTC layer 820. During an over current/over temperature condition, the resistance of the PTC layer 820 increases to thereby reduce current flow through the rest of the layers. In this way, the PTC layer 820 protects the battery 800.

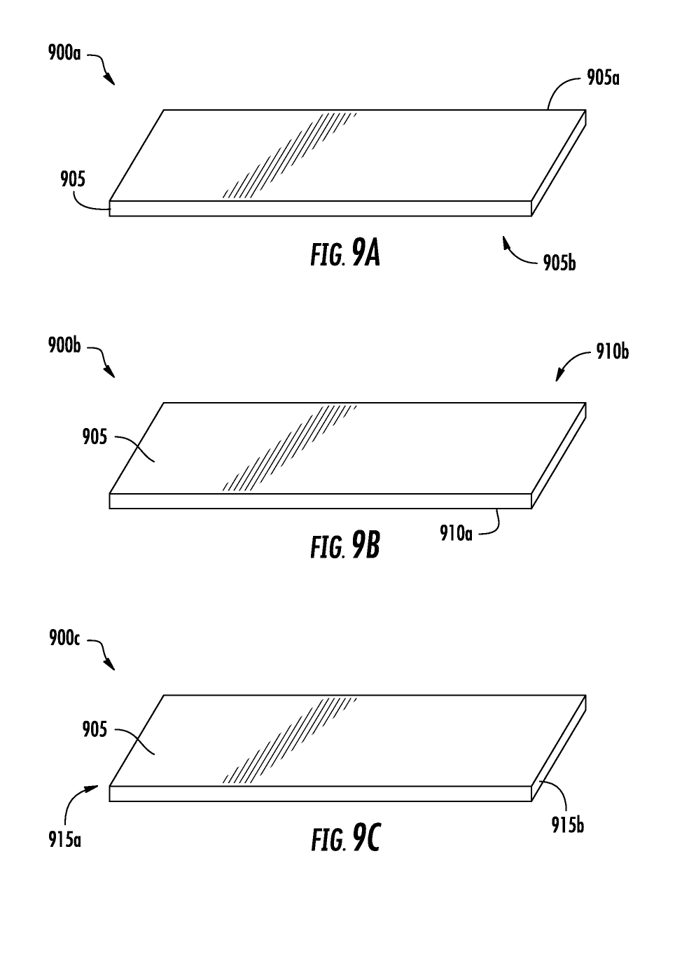

FIGS. 9A-9C illustrate an exemplary free standing embodiments 900a-c of PTC devices that incorporate the an ultrathin PTC sheet/layer 905 formed by either of the processes described above. In a first exemplary embodiment 900a, conductive layers 905ab may be formed on the top and the bottom surfaces of the PTC sheet 905. In this embodiment, the current is intended to flow through the thinnest section of the PTC sheet 905. Such an embodiment could be retroactively applied between layers of a different device, such as the layers of a battery, to provide overcurrent/over temperature protection.

In the second and third exemplary embodiment, conductive layers 910ab may be formed on the front and back surfaces of the PTC sheet 905. (See FIG. 9B) or conductive layers 915ab may be formed on left and right surfaces of the PTC sheet 905. (See FIG. 9C). In the second and third embodiments, the current is intended to flow through one of the longitudinal sections of the PTC sheet 905. Placement of the conductive layers on the other surfaces and/or on different regions of any given surface facilities controlling the direction of current flow through the PTC sheet 905, which may be advantageous in certain applications.

While the method for manufacturing the ultrathin PTC sheet has been described with reference to certain embodiments, it will be understood by those skilled in the art that various changes may be made and equivalents may be substituted without departing from the spirit and scope of the claims of the application. Other modifications may be made to adapt a particular situation or material to the teachings disclosed above without departing from the scope of the claims. Therefore, the claims should not be construed as being limited to any one of the particular embodiments disclosed, but to any embodiments that fall within the scope of the claims.

We claim:

1. A method for manufacturing a sheet of positive temperature coefficient (PTC) material, the method comprising:
providing a PTC material;
grinding the PTC material into a powder;
inserting the ground PTC material into a press;
compressing the ground PTC material until the PTC material defines a planar shape; and
removing the compressed PTC material from the press.

2. The method according to claim 1, wherein the PTC material is ground to produce PTC particles that have a median diameter of between about 0.1 μm and 50 μm.

3. The method according to claim 1, wherein the PTC material comprises a conductive filler and a polymer resin, wherein the conductive filler includes one or more of: metal, metal ceramic, carbon tungsten carbide, nickel, carbon, and titanium carbide, and the polymer resin includes one or more of: semi-crystalline polymer-fluoropolymers such as (polyvinylidene difluoride, ethylene tetrafluoroethylene) ethylene-vinyl acetate, and ethylene butyl acrylate, polyethylene, polypropylene, polyamide, polymethyl methacrylate, polyurethane, Polyether ether ketone.

4. The method according to claim 3, wherein the conductive filler comprises conductive particles having an irregular, spherical, fiber, flake, or dendritic shape and a D50 particle size of between 0.1 μm to 50 μm.

5. The method according to claim 1, wherein the compressed PTC material has a thickness of less than 130 μm.

6. The method according to claim 1, further comprising providing a substrate and compressing the ground PTC material against the substrate so that the PTC material forms a planar layer on a surface of the substrate.

7. A method for manufacturing a sheet of positive temperature coefficient (PTC) material, the method comprising:
mixing a conductive filler and a dissolved polymer into a PTC ink solution;
spreading the PTC ink solution over a planar surface; and
drying the PTC ink solution to thereby provide a PTC material that defines a planar shape.

8. The method according to claim 7, further comprising pealing the dried PTC material from the planar surface and cutting the PTC material into a desired shape.

9. The method according to claim 7, wherein the planar surface corresponds to a conductive substrate, wherein the method further comprises cutting the PTC material with the conductive substrate into a desired shape.

10. The method according to claim 7, wherein mixing the conductive filler and the dissolved polymer comprises mixing the conductive filler and the dissolved polymer with a solvent, wherein the solvent includes one or more of: dimethylformamide, and n-methyl-2-pyrrolidone, tetrahydrofuran, tricholorobenzene, dichlorobenzene, dimethylacetamide, dimethyl sulfoxide, cyclohexane, toluene.

11. The method according to claim 7, wherein the conductive filler comprises conductive particles having an irregular, spherical, fiber, flake, dendritic shape and size of between 0.1 μm to 50 μm and the dissolved polymer comprises polymer particles having a powder, pellet or bead form and having a size between 0.1 μm to 1 mm.

12. The method according to claim 7, wherein the conductive filler includes one or more of: tungsten carbide, nickel, carbon, and titanium carbide, metal, metal ceramic carbon and the dissolved polymer includes one or more of: polyvinylidene difluoride, polyethylene, ethylene tetrafluoroethylene, ethylene-vinyl acetate, ethylene butyl acrylate, tetrahydrofuran, tricholorobenzene, dichlorobenzene, dimethylacetamide, dimethyl sulfoxide, cyclohexane, and toluene.

13. The method according to claim 7, wherein the dried PTC material has a thickness of less than 130 μm.

14. A positive temperature coefficient (PTC) device comprising:
a conductive filler; and
a polymer resin;
wherein the PTC device includes first and second opposite surfaces, wherein a distance between the first and second opposite surfaces is less than 130 μm.

15. The PTC device according to claim 14, further comprising a conductive substrate disposed on at least one of the first and second opposite surfaces.

16. The PTC device according to claim 14, wherein the conductive filler includes one or more of: tungsten carbide, nickel, carbon, and titanium carbide, metal, metal ceramic carbon, and the polymer resin includes one or more of: polyvinylidene difluoride, polyethylene, ethylene tetrafluoroethylene, ethylene-vinyl acetate, and ethylene butyl acrylate.

17. The PTC device according to claim 14, further comprising a conductive substrate disposed on third and fourth opposite surfaces.
